(19) United States
(12) Patent Application Publication
(10) Pub. No.: US 2026/0317592 A1
(43) Pub. Date: Oct. 15, 2026

(54) ELECTRICALLY PEELABLE COMPOSITION, PREPARATION METHOD THEREOF, AND ADHESIVE PRODUCT

(71) Applicant: STEADYCHEM (SHANGHAI) CO., LTD., Shanghai (CN)

(72) Inventors: Liangjun LI, Shanghai (CN); Wangsheng Fang, Shanghai (CN)

(21) Appl. No.: 19/462,268

(22) Filed: Jan. 28, 2026

Related U.S. Application Data
(63) Continuation of application No. PCT/CN2025/102786, filed on Jun. 23, 2025.

(30) Foreign Application Priority Data
Jul. 3, 2024 (CN) 202410890591.8

(51) Int. Cl. C09J 7/38; C09J 11/06; C09J 11/08

(52) U.S. Cl. CPC C09J 7/385; C09J 11/06; C09J 11/08; C09J 2203/37; C09J 2301/314; C09J 2301/408; C09J 2301/414

(57) ABSTRACT

The present disclosure provides an electrically peelable composition, a preparation method thereof, and an adhesive product, belonging to the field of chemical materials. The electrically peelable composition provided in the present disclosure includes the following components: an acrylate-based polymer, an ionic liquid, an auxiliary agent A, and an auxiliary agent B; the auxiliary agent A accounts for 10%-30% of a total weight of the acrylate-based polymer; a mass ratio of the auxiliary agent A to the auxiliary agent B is (10-30):(1-10); and the auxiliary agent A and the auxiliary agent B are configured to undergo a synergistic crosslinking reaction with the acrylate-based polymer. Through the optimized design of components of the electrically peelable composition, the present disclosure significantly improves adhesive retention of an adhesive product prepared from the electrically peelable composition, and effectively achieves both electrical peelability and adhesive properties of the adhesive product.

### TECHNICAL FIELD

The present disclosure belongs to the field of chemical materials, and in particular to an electrically peelable composition, a preparation method thereof, and an adhesive product.

### BACKGROUND

In the process of manufacturing electronic components, in order to improve the reprocessability of finished products and meet the requirements for recycling and reuse, it is necessary to provide adhesive products with excellent adhesive properties and easy peelability; and after being attached to an adherend, an adhesive product should exhibit strong adhesive strength, and be easily removable from the adherend during peeling to ensure the recyclability of the adherend.

An adhesive product in the prior art is usually made of an electrically peelable composition, and during peeling, a voltage is applied to reduce the adhesive strength of the adhesive product, such that the adhesive product is peeled from an adherend; and however, the adhesive product prepared from the electrically peelable composition has the defect of poor cohesion due to the inhibition of raw material components, thereby resulting in poor adhesive retention of the adhesive product, and failure to effectively balance electrical peelability and adhesive properties.

In view of this, the present disclosure is provided.

### SUMMARY

The present disclosure provides an electrically peelable composition, a preparation method thereof, and an adhesive product, aiming to overcome the defects of adhesive products in the prior art including poor adhesive retention and failure to effectively balance electrical peelability and adhesive properties.

In a first aspect of the present disclosure, an electrically peelable composition is provided, including the following components: an acrylate-based polymer, an ionic liquid, an auxiliary agent A, and an auxiliary agent B; the auxiliary agent A accounts for 10%-30% of a total weight of the acrylate-based polymer; a mass ratio of the auxiliary agent A to the auxiliary agent B is (10-30):(1-10); and the auxiliary agent A and the auxiliary agent B are configured to undergo a synergistic crosslinking reaction with the acrylate-based polymer.

The present disclosure optimizes raw material components of the electrically peelable composition, and employs the acrylate-based polymer, the ionic liquid, the auxiliary agent A, and the auxiliary agent B as main raw materials; where the acrylate-based polymer endows the electrically peelable composition with adhesive properties, and the ionic liquid enables an adhesive layer formed by the electrically peelable composition to have the characteristic of easy electrical peelability; the auxiliary agent A undergoes a crosslinking reaction with the acrylate-based polymer, such that the adhesive layer formed by the electrically peelable composition has high peeling strength prior to electrification and is not easily peeled from an adherend; and the auxiliary agent B undergoes a crosslinking reaction with the acrylate-based polymer to cure into a film, which facilitates the formation of the adhesive layer by the electrically peelable composition.

It is particularly critical that the auxiliary agent A accounts for 10%-30% of a total weight of the acrylate-based polymer, a mass ratio of the auxiliary agent A to the auxiliary agent B is (10-30):(1-10), and within this weight range, the auxiliary agent A, the auxiliary agent B, and the acrylate-based polymer undergo a synergistic crosslinking reaction, such that the electrically peelable composition has an appropriate crosslinking density, which significantly improves the cohesion of the electrically peelable composition, greatly improves the adhesive retention of the adhesive layer formed by the electrically peelable composition, and effectively balances electrical peelability and adhesive properties.

Thus, due to the synergistic compatibility of raw material components such as the acrylate-based polymer, the ionic liquid, the auxiliary agent A, and the auxiliary agent B, cohesive strength of the electrically peelable composition provided by the present disclosure is significantly improved, and the adhesive layer formed by the electrically peelable composition has high peeling strength and adhesive retention before electrification, and is easily peeled from the adherend after electrification, such that an adhesive product prepared from the electrically peelable composition has both electrical peelability and excellent adhesive properties.

In some embodiments, the electrically peelable composition satisfies one or more of the following conditions A to H:
A) in parts by weight, relative to 100 parts of the acrylate-based polymer, the electrically peelable composition includes 2-30 parts of the ionic liquid, 10-30 parts of the auxiliary agent A, and 1-10 parts of the auxiliary agent B;
B) the auxiliary agent A includes a linear resin containing active functional groups with a molecular weight of 200-1,000;
C) the auxiliary agent B includes a UV-curable resin and/or a non-UV-curable resin;
D) an anion of the ionic liquid is a bis(fluorosulfonyl)imide anion;
E) a cation of the ionic liquid includes one or more of a nitrogen-containing onium cation, a sulfur-containing onium cation, a phosphorus-containing onium cation, an imidazolium-based cation, an ammonium-based cation, or a pyridinium-based cation;
F) solid content of the acrylate-based polymer is 10-50%;
G) a weight-average molecular weight of the acrylate-based polymer is 100,000 to 5,000,000, preferably 200,000 to 4,000,000, and more preferably 300,000 to 3,000,000; and
H) a glass transition temperature of the acrylate-based polymer is below 0° C., preferably below −20° C., and more preferably below −40° C.

In some embodiments, the auxiliary agent A includes one or more of a rosin-based carboxyl-containing tackifying resin, an epoxy-based epoxy-containing tackifying resin, a phenol-based hydroxyl-containing tackifying resin, an acrylate-based tackifying resin, and resins represented by the following formulas I, II, and III,

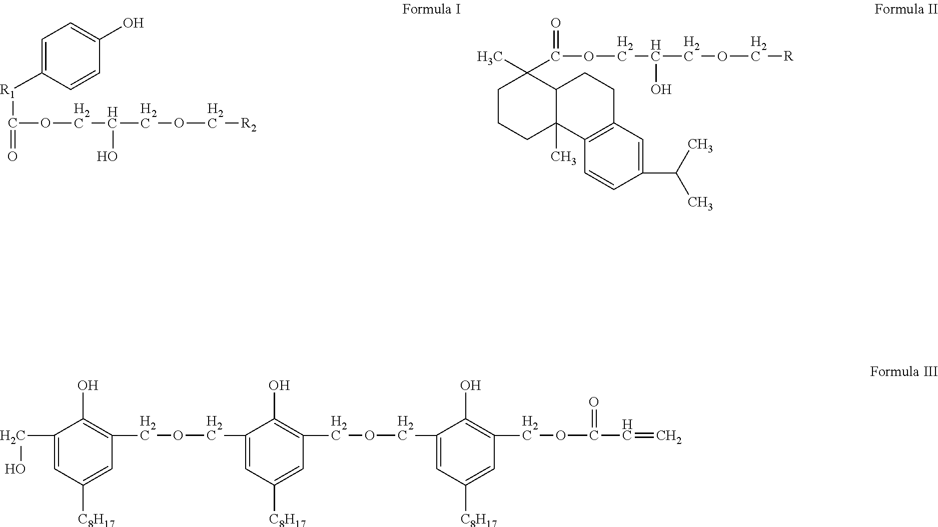

where R₁ represents a phenyl group, a cyclohexyl group, or a methylene group; R₂ represents a methyl group, a hydroxyl group, a vinyl group, a carboxyl group, an epoxy group, a mercapto group, or an acryloyloxy group; and R represents a methyl group, a hydroxyl group, a vinyl group, a carboxyl group, an epoxy group, a mercapto group, or an acryloyloxy group. In some embodiments, as a non-UV-curable resin, the auxiliary agent B includes one or more of an isocyanate-based crosslinking agent, an epoxy-based crosslinking agent, an aziridine-based crosslinking agent, or a metal chelate-based crosslinking agent; or as a UV-curable resin, the auxiliary agent B includes one or more of epoxy acrylate, polyurethane acrylate, or polyester acrylate.

In some embodiments, the acrylate-based polymer is made from main raw materials including a principal unit, a functional unit, and an initiator; where the principal unit is alkyl (meth)acrylate containing an alkyl group with 1-14 carbon atoms; the functional unit includes a carboxyl-containing acrylate-based monomer and/or a hydroxyl-containing acrylate-based monomer; and the initiator includes either a thermal polymerization initiator or a photoinitiator.

In some embodiments, the acrylate-based polymer satisfies one or more of the following conditions I to M:
I) when the initiator is a thermal polymerization initiator, a mass ratio of the principal unit to the functional unit is (70-95):(5-30);
J) when the initiator is a photoinitiator, raw materials of the acrylate-based polymer further include a multifunctional UV monomer; a mass ratio of the principal unit to the functional unit and to the multifunctional UV monomer is (60-95):(3-30):(2-10), preferably (60-85):(10-30):(5-10);
K) the raw materials of the acrylate-based polymer further include a polymerization solvent, and the polymerization solvent includes one or more of an aliphatic hydrocarbon, an ester compound, and an aromatic hydrocarbon;
L) the thermal polymerization initiator includes any one of azo polymerization initiators such as 2,2′-azobisisobutyronitrile, 2,2′-azobis(2-methylpropionamidine)disulfide, 2,2′-azobis(4-methoxy-2,4-dimethylvaleronitrile), 2,2′-azobis(2,4-dimethylvaleronitrile), 2,2′-azobis(2-methylbutyronitrile), 1, l′-azobis(cyclohexane-1-carbonitrile), dimethyl-2,2′-azobis(2-methylpropanoate), dihydrochloride, 2,2′-azobis [2-methyl-N-(phenylmethyl) propionamidine]2,2′-azobis(2,4,4-trimethylpentane), 2,2′-azobis [2-(3,4,5,6-tetrahydropyrimidin-2-yl) propane]dihydrochloride, or 2,2′-azobis [2-(2-imidazolin-2-yl) propane], or any one of persulfate compounds such as potassium persulfate or ammonium persulfate; and
M) the photoinitiator includes any one of Type I photoinitiators such as hydroxypropiophenone, alkylaminoacetophenone, benzoin ether, or phosphine oxide, or any one of Type II initiators such as benzophenone, substituted benzophenone, anthraquinone, benzoylformate, camphorquinone, or thioxanthone.

In a second aspect of the present disclosure, a method for preparing the electrically peelable composition is provided, including:
step of preparing an acrylate-based polymer: mixing a principal unit, a functional unit, and a polymerization solvent with a thermal polymerization initiator in a predetermined ratio for reaction to obtain an acrylate-based polymer A; or mixing a principal unit, a functional unit, a multifunctional UV monomer, and a polymerization solvent with a photoinitiator in a predetermined ratio for reaction to obtain an acrylate-based polymer B; and
step of preparing an electrically peelable composition: mixing the acrylate-based polymer A or the acrylate-based polymer B with remaining components in a predetermined ratio for reaction to obtain an electrically peelable composition.

In some embodiments, the step of preparing an acrylate-based polymer specifically includes:
mixing a monomer mixture A composed of a principal unit and a functional unit with a polymerization solvent at a mass ratio of 1:(1-9), and adding a thermal polymerization initiator accounting for 0.2-1% by mass of the monomer mixture A for a heating reaction to obtain an acrylate-based polymer A; or
mixing a monomer mixture B composed of a principal unit, a functional unit, and a multifunctional UV monomer with a polymerization solvent at a mass ratio of 1:(1-9), and adding a photoinitiator accounting for 1-5% by mass of the monomer mixture B for a reaction under UV irradiation to obtain an acrylate-based polymer B.

In some embodiments, in the step of preparing an electrically peelable composition, when an acrylate-based polymer B is mixed with remaining components in a predetermined ratio for reaction, the remaining components further include a photoinitiator accounting for 1-5% of a total mass of the acrylate-based polymer B.

In a third aspect of the present disclosure, an adhesive product is provided, including an adhesive layer formed by the above electrically peelable composition or the electrically peelable composition prepared by the above preparation method.

### DETAILED DESCRIPTIONS OF THE EMBODIMENTS

The “range” disclosed in the present disclosure is defined in the form of a lower limit and an upper limit, and a given range is defined by selecting a lower limit and an upper limit, where the lower limit and the upper limit define boundaries of a specific range. A range defined in this way may include or exclude endpoints, and may be arbitrarily combined, that is, any lower limit may be combined with any upper limit to form a range. For example, if ranges of 60-120 and 80-110 are listed for a specific parameter, it is understood that ranges of 60-110 and 80-120 are also contemplated. Additionally, if minimum range values 1 and 2 are listed, and maximum range values 3, 4, and 5 are listed, the following ranges are all contemplated: 1-3, 1-4, 1-5, 2-3, 2-4, and 2-5. In the present disclosure, unless otherwise specified, a numerical range “a-b” is an abbreviated representation of any combination of real numbers between a and b, where a and b are both real numbers. For example, a numerical range “0-5” indicates that all real numbers between “0-5” have been listed herein, and “0-5” is only an abbreviated representation of these numerical combinations. Additionally, when a parameter is expressed as an integer ≥2, it is equivalent to disclosing that the parameter is an integer such as 2, 3, 4, 5, 6, 7, 8, 9, 10, 11, 12, etc.

Unless otherwise specified, all embodiments and optional embodiments of the present disclosure may be combined with each other to form new technical solutions.

Unless otherwise specified, all technical features and optional technical features of the present disclosure may be combined with each other to form new technical solutions.

Unless otherwise specified, all steps of the present disclosure may be performed sequentially or randomly, preferably sequentially. For example, the method includes steps (a) and (b), which means the method may include steps (a) and (b) performed sequentially, or steps (b) and (a) performed sequentially. For example, when it is mentioned that the method may further include a step (c), it means the step (c) may be added to the method in any order, for example, the method may include steps (a), (b), and (c), or steps (a), (c), and (b), or steps (c), (a), and (b), etc.

Unless otherwise specified, “including” and “comprising” mentioned in the present disclosure are open-ended or closed-ended. For example, “including” and “comprising” may further include or comprise other unlisted components, or may only include or comprise the listed components.

Unless otherwise specified, the term “or” in the present disclosure is inclusive. For example, the phrase “A or B” means “A, B, or both A and B”. More specifically, any of the following conditions satisfies the condition “A or B”: A is true (or exists) and B is false (or does not exist); A is false (or does not exist) and B is true (or exists); or both A and B are true (or exist).

As mentioned above, the general inventive concept of the embodiments of the present disclosure is to provide an electrically peelable composition. Raw material components such as an acrylate-based polymer, an ionic liquid, an auxiliary agent A, and an auxiliary agent B are designed, where the adopted auxiliary agent A, the auxiliary agent B, and the acrylate-based polymer undergo a synergistic crosslinking reaction at a specific ratio, such that the cohesion of the electrically peelable composition is greatly improved, an adhesive layer formed by the electrically peelable composition has high peeling strength and strong adhesive retention before electrification, and an adhesive product prepared from the electrically peelable composition has both electrical peelability and adhesive properties.

Based on the above inventive concept, an electrically peelable composition provided by the embodiments of the present disclosure includes the following components: an acrylate-based polymer, an ionic liquid, an auxiliary agent A, and an auxiliary agent B; the auxiliary agent A accounts for 10%-30% of a total weight of the acrylate-based polymer; a mass ratio of the auxiliary agent A to the auxiliary agent B is (10-30):(1-10); and the auxiliary agent A and the auxiliary agent B are configured to undergo a synergistic crosslinking reaction with the acrylate-based polymer.

It should be noted that the ionic liquid in the embodiments of the present disclosure refers to a salt that is liquid at room temperature, also known as a room-temperature molten salt. The ionic liquid is mainly composed of cations and anions, and has characteristics such as heat resistance, non-flammability, non-volatility, and chemical stability; and when a voltage is applied, the ionic liquid undergoes electrolysis, and adhesive strength of the adhesive layer formed by the electrically peelable composition is reduced, such that the adhesive product prepared from the electrically peelable composition has the characteristic of electrical peelability.

It should be understood that the introduction of the ionic liquid usually inhibits a crosslinking density of the electrically peelable composition, and reduces the cohesion. However, synergistic crosslinking of components (the auxiliary agent A and the auxiliary agent B in the present disclosure) with the acrylate-based polymer effectively overcomes the loss of crosslinking density caused by the introduction of the ionic liquid, such that the electrically peelable composition has an appropriate crosslinking density, the cohesion of the electrically peelable composition is significantly improved, and the adhesive layer formed by the electrically peelable composition has excellent adhesive retention and electrical peelability.

Additionally, the auxiliary agent A accounts for 10%-30% of a total weight of the acrylate-based polymer, and within this weight range, the auxiliary agent A and the auxiliary agent B crosslink with the acrylate-based polymer, thereby effectively improving the crosslinking density and effectively improving the cohesion of the electrically peelable composition; and when the auxiliary agent A accounts for less than 10% of the total weight of the acrylate-based polymer, the synergistic effect of the auxiliary agent A and the auxiliary agent B on the acrylate-based polymer is poor, and the adhesive layer formed by the prepared electrically peelable composition has low peeling strength before electrification and is easily peeled from an adherend, while when the auxiliary agent A accounts for more than 30% of the total weight of the acrylate-based polymer, the cohesive strength of the electrically peelable composition is severely attenuated, and the adhesive retention of the adhesive layer formed by the electrically peelable composition is poor.

Additionally, a mass ratio of the auxiliary agent A to the auxiliary agent B is (10-30):(1-10), and at this mass ratio, the auxiliary agent B and the auxiliary agent A jointly crosslink with the acrylate-based polymer, such that the cohesion of the electrically peelable composition is significantly improved, and the adhesive retention and electrical peelability of the adhesive layer formed by the electrically peelable composition are balanced; for the mass ratio of the auxiliary agent A to the auxiliary agent B, when a mass proportion of the auxiliary agent B is too low, the crosslinking density of the electrically peelable composition is low, the cohesion of the electrically peelable composition is low, and the adhesive retention of the adhesive layer formed by the electrically peelable composition is poor, while when a mass proportion of the auxiliary agent B is too high, the crosslinking density of the electrically peelable composition is too high, resulting in that the adhesive layer formed by the electrically peelable composition has the peeling strength significantly reduced, which cannot be stably adhered to the adherend when no voltage is applied.

Thus, due to the synergistic compatibility of raw material components such as the acrylate-based polymer, the ionic liquid, the auxiliary agent A, and the auxiliary agent B, cohesion of the electrically peelable composition provided by the present disclosure is significantly improved, and the adhesive layer formed by the electrically peelable composition has high peeling strength and adhesive retention before electrification, and has both electrical peelability and excellent adhesive properties.

It should be clarified that the auxiliary agent A accounts for 10%-30% of a total weight of the acrylate-based polymer, and for example, the auxiliary agent A may specifically account for 10%, 11%, 12%, 13%, 14%, 15%, 16%, 17%, 18%, 19%, 20%, 21%, 22%, 23%, 24%, 25%, 26%, 27%, 28%, 29%, 30%, or any weight percentage within a range of 10%-30% of the total weight of the acrylate-based polymer; and a mass ratio of the auxiliary agent A to the auxiliary agent B is (10-30):(1-10), and for example, a mass ratio of the auxiliary agent A to the auxiliary agent B may be 10:1, 10:2, 10:3, 10:4, 10:5, 10:6, 10:7, 10:8, 10:9, 10:10, 15:1, 15:2, 15:3, 15:4, 15:5, 15:6, 15:7, 15:8, 15:9, 15:10, 20:1, 20:2, 20:3, 20:4, 20:5, 20:6, 20:7, 20:8, 20:9, 20:10, 25:1, 25:2, 25:3, 25:4, 25:5, 25:6, 25:7, 25:8, 25:9, 25:10, 30:1, 30:2, 30:3, 30:4, 30:5, 30:6, 30:7, 30:8, 30:9, 30:10, or any mass ratio within a range of (10-30):(1-10).

In some embodiments, the mass ratio of the auxiliary agent A to the auxiliary agent B is preferably (10-30):(1-5), more preferably (15-25):(1-5). The preferred design of the mass ratio of the auxiliary agent A to the auxiliary agent B facilitates more sufficient crosslinking of the auxiliary agent B and the auxiliary agent A with the acrylate-based polymer, such that the cohesion of the electrically peelable composition is further improved, and the adhesive retention and electrical peelability of the adhesive layer formed by the electrically peelable composition are balanced.

In some embodiments, in parts by weight, relative to 100 parts of the acrylate-based polymer, the electrically peelable composition includes 2-30 parts of the ionic liquid, 10-30 parts of the auxiliary agent A, and 1-10 parts of the auxiliary agent B. Relative to 100 parts of the acrylate-based polymer, the design of 2-30 parts of the ionic liquid, 10-30 parts of the auxiliary agent A, and 1-10 parts of the auxiliary agent B effectively improves the cohesive strength of the electrically peelable composition, and the adhesive layer formed by the electrically peelable composition has high peeling strength and adhesive retention before electrification, is easily peeled from the adherend after electrification, and has both electrical peelability and excellent adhesive properties. For example, relative to 100 parts of the acrylate-based polymer, 2, 3, 4, 5, 6, 7, 8, 9, 10, 11, 12, 13, 14, 15, 16, 17, 18, 19, 20, 21, 22, 23, 24, 25, 26, 27, 28, 29, 30 parts, or any parts of the ionic liquid by weight within a range of 2-30 parts may be designed; 10, 11, 12, 13, 14, 15, 16, 17, 18, 19, 20, 21, 22, 23, 24, 25, 26, 27, 28, 29, 30 parts, or any parts of the auxiliary agent A by weight within a range of 10-30 parts may be designed; and 1, 2, 3, 4, 5, 6, 7, 8, 9, 10 parts, or any parts of the auxiliary agent B by weight within a range of 1-10 parts may be designed.

In some embodiments, in parts by weight, relative to 100 parts of the acrylate-based polymer, 1-5 parts of the auxiliary agent B are preferably designed, which further promotes the crosslinking of the acrylate-based polymer, such that the cohesion of the electrically peelable composition is further improved, and the adhesive retention and electrical peelability of the adhesive layer formed by the electrically peelable composition are balanced.

In some embodiments, in parts by weight, relative to 100 parts of the acrylate-based polymer, 2-15 parts (more preferably 2-9 parts) of the ionic liquid are preferably designed, and the preferred design of parts by weight of the ionic liquid is more conducive to reducing the impact on the crosslinking density of the electrically peelable composition, such that the cohesion of the electrically peelable composition is further improved, and the adhesive retention and electrical peelability of the adhesive layer formed by the electrically peelable composition are balanced. When less than 2 parts of the ionic liquid are designed, the electrical peelability of the adhesive layer formed by the electrically peelable composition after electrification is sharply attenuated, and a balance between adhesive retention and electrical peelability cannot be achieved.

In some embodiments, the auxiliary agent A includes a linear resin containing active functional groups with a molecular weight of 200-1,000, the resin containing active functional groups undergoes a crosslinking reaction with the acrylate-based polymer, and due to a low molecular weight of the resin containing active functional groups, the auxiliary agent A has high reactivity, which improves the effect of its synergistic crosslinking with the acrylate-based polymer, improves the crosslinking density of the electrically peelable composition, and improves the cohesion of the electrically peelable composition, such that the adhesive layer formed by the electrically peelable composition has high adhesive retention.

In some embodiments, the auxiliary agent B includes a UV-curable resin and/or a non-UV-curable resin. The UV-curable resin or the non-UV-curable resin as the auxiliary agent B undergoes a crosslinking reaction with the acrylate-based polymer to cure into a film, which makes up for the loss of crosslinking density caused by the introduction of the ionic liquid, and improves the cohesion of the electrically peelable composition, such that the adhesive layer formed by the electrically peelable composition has high adhesive retention. The UV-curable resin as the auxiliary agent B participates in a free radical polymerization reaction with the acrylate-based polymer, which further improves the crosslinking density, and greatly improves the cohesive strength of the electrically peelable composition, such that the adhesive layer formed by the electrically peelable composition has higher adhesive retention.

In some embodiments, the auxiliary agent A may specifically be a reactive tackifying resin, and the auxiliary agent A includes one or more of a rosin-based carboxyl-containing tackifying resin, an epoxy-based epoxy-containing tackifying resin, a phenol-based hydroxyl-containing tackifying resin, an acrylate-based tackifying resin, and resins represented by the following formulas I, II, and III,

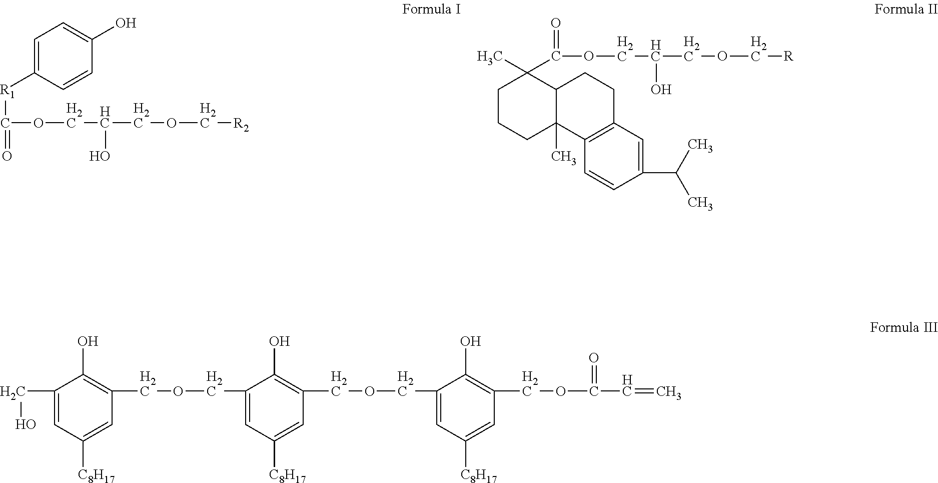

where R₁ represents a phenyl group, a cyclohexyl group, or a methylene group; R₂ represents a methyl group, a hydroxyl group, a vinyl group, a carboxyl group, an epoxy group, a mercapto group, or an acryloyloxy group; and R represents a methyl group, a hydroxyl group, a vinyl group, a carboxyl group, an epoxy group, a mercapto group, or an acryloyloxy group.

The above substances are all reactive tackifying resins, and as the auxiliary agent A, they ensure that the electrically peelable composition has high peeling strength before electrification, and synergistically crosslinks with the acrylate-based polymer to improve the crosslinking density of the electrically peelable composition, such that the adhesive retention of the adhesive layer formed by the electrically peelable composition is effectively improved.

It should be noted that the auxiliary agent A may be obtained commercially, and for example, the rosin-based carboxyl-containing tackifying resin may be ARDYME R-9520 purchased from Arakawa Chemical, and the resin of Formula I may be TSR-6000 purchased from Yiqing Chemical, but it is not limited thereto. Additionally, when a target structure of any of the resins of Formulas I, II, and III is known, the resin having any structure shown in Formulas I, II, and III may be prepared by conventional synthesis or modification methods based on raw materials of the prior art such as resins and organic monomers. For example, the resin of Formula II may be obtained by modifying disproportionated rosin, and the resin of Formula III may be obtained by modifying p-tert-octylphenol formaldehyde resin, but it is not limited thereto.

It should be noted that the auxiliary agent A is a reactive tackifying resin rather than a non-reactive tackifying resin, because the non-reactive tackifying resin cannot synergistically crosslink with the acrylate-based polymer, that is, the crosslinking density of the electrically peelable composition cannot be improved; and moreover, the introduction of the non-reactive tackifying resin inhibits the crosslinking of the acrylate-based polymer, resulting in that the cohesion of the electrically peelable composition is sharply reduced, thereby further leading to poor retention of the adhesive layer formed by the electrically peelable composition.

In some embodiments, as a non-UV-curable resin, the auxiliary agent B includes one or more of an isocyanate-based crosslinking agent, an epoxy-based crosslinking agent, an aziridine-based crosslinking agent, or a metal chelate-based crosslinking agent; and the above substances as non-UV-curable resin all participate in crosslinking with the acrylate-based polymer, which improves the crosslinking density of the electrically peelable composition, thereby improving the cohesion of the electrically peelable composition.

In some embodiments, as a UV-curable resin, the auxiliary agent B includes one or more of epoxy acrylate, polyurethane acrylate, or polyester acrylate; and the above substances as UV-curable resin all participate in crosslinking with the acrylate-based polymer, which further improves the crosslinking density of the electrically peelable composition, such that the electrically peelable composition has higher cohesion.

In some embodiments, the auxiliary agent B is a combination of a UV-curable resin and a non-UV-curable resin.

In some embodiments, an anion of the ionic liquid is a bis(fluorosulfonyl)imide anion; the bis(fluorosulfonyl)imide anion has high thermal stability and chemical stability, and maintains its performance over a wide range of temperatures and chemical environments; and additionally, the bis(fluorosulfonyl)imide anion also helps to improve the conductivity of the electrically peelable composition, such that when a voltage is applied to the adhesive layer formed by the electrically peelable composition, an adhesive interface quickly reduces the adhesive strength, thereby achieving the rapid peeling of the adhesive layer from the adherend.

In some embodiments, a cation of the ionic liquid includes one or more of a nitrogen-containing onium cation, a sulfur-containing onium cation, a phosphorus-containing onium cation, an imidazolium-based cation, an ammonium-based cation, or a pyridinium-based cation; and the above cations all have excellent ionic conductivity and chemical stability, and migrate quickly under the action of voltage, such that the adhesive layer formed by the electrically peelable composition is endowed with better electrical peelability.

For example, the ionic liquid in the examples of the present disclosure may be obtained from Dai-ichi Kogyo Seiyaku Co., Ltd., Kanto Chemical Co., Inc., Koei Chemical Industry Co., Ltd., etc. For example, 1-ethyl-3-methylimidazolium bis(fluorosulfonyl)imide (AS-110) may be obtained from Dai-ichi Kogyo Seiyaku Co., Ltd., 1-hexylpyridinium bis(trifluoromethanesulfonyl)imide, N-butyl-N-methylpyrrolidinium bis(trifluoromethanesulfonyl)imide, and 1-ethyl-3-methylimidazolium tetrafluoroborate may be obtained from Kanto Chemical Co., Inc., and 1-ethyl-3-methylimidazolium hexafluorophosphate (IL-C3), 1-butylpyridinium tetrafluoroborate (IL-P10), 1-hexylpyridinium bis(trifluoromethanesulfonyl)imide (IL-P14), and 1-ethyl-3-methylimidazolium bis(trifluoromethanesulfonyl)imide (EMI-TFSI) may be obtained from Koei Chemical Industry Co., Ltd.

In some embodiments, solid content of the acrylate-based polymer is 10-50%; and within this solid content range, the acrylate-based polymer is in a solution state, which facilitates the dispersion of the ionic liquid and the synergistic crosslinking with the auxiliary agent A and the auxiliary agent B, such that the adhesive layer formed by the electrically peelable composition has both electrical peelability and adhesive retention.

In some embodiments, a weight-average molecular weight of the acrylate-based polymer is 100,000 to 5,000,000, preferably 200,000 to 4,000,000, and more preferably 300,000 to 3,000,000; and a weight-average molecular weight of the acrylate-based polymer is 100,000 to 5,000,000, such that the adhesive layer formed by the electrically peelable composition has lower cohesion after electrification and is easily peeled from the adherend without residual colloid after peeling from the adherend, thereby ensuring the recyclability of the adherend.

It should be noted that the weight-average molecular weight in the examples of the present disclosure refers to a value calculated using Shodex's GPC (System21) with tetrahydrofuran as a mobile phase, and the value is a weight-average molecular weight converted to polystyrene.

In some examples, a glass transition temperature of the acrylate-based polymer is below 0° C., preferably below −20° C., and more preferably below −40° C., which improves the initial adhesive strength of the adhesive layer formed by the electrically peelable composition during the bonding process.

The glass transition temperature (Tg) in this example is calculated based on the following Formula IV (Fox formula):

$$1 / Tg = {W}_{1} / {Tg}_{1} + {W}_{2} / {Tg}_{2} + ⋯ + {W}_{n} / {Tg}_{n} \qquad ( IV )$$

where Tg represents a glass transition temperature of a polymer (unit: K), Tgᵢ (i=1, 2, . . . n) represents a glass transition temperature of a homopolymer formed by a monomer i (unit: K), Wᵢ (i=1, 2, . . . n) represents a weight fraction of the monomer i in all monomer components, and the above Formula (IV) is a calculation formula for the case where the polymer is composed of n monomer components: monomer 1, monomer 2, . . . , monomer n. Additionally, the glass transition temperature when the homopolymer is formed refers to the glass transition temperature of the homopolymer of the monomer, and refers to the glass transition temperature (Tg) of the polymer formed by using only a certain monomer as a monomer component.

In some examples, the acrylate-based polymer is made from main raw materials including a principal unit, a functional unit, and an initiator; where the principal unit is alkyl (meth)acrylate containing an alkyl group with 1-14 carbon atoms; the alkyl (meth)acrylate containing an alkyl group with 1-14 carbon atoms serves as the principal unit, and polymerizing to form the acrylate-based polymer ensures the curing and film formation of the electrically peelable composition; the functional unit includes a carboxyl-containing acrylate-based monomer and/or a hydroxyl-containing acrylate-based monomer, and after these carboxyl-containing and/or hydroxyl-containing acrylate-based monomers as functional units are polymerized with the principal unit under the action of an initiator, a resulting acrylate-based polymer crosslinks with the auxiliary agent A and the auxiliary agent B, such that the electrically peelable composition is cured into a film and has high cohesion, thereby effectively improving the adhesive retention of the adhesive layer formed by the electrically peelable composition; and the initiator includes either a thermal polymerization initiator or a photoinitiator, and both the thermal polymerization initiator and the photoinitiator are capable of initiating the polymerization reaction of monomer molecules, such that monomers such as the principal unit and the functional unit are polymerized to form the acrylate-based polymer.

In some examples, the functional unit may be a single carboxyl-containing acrylate-based monomer, a single hydroxyl-containing acrylate-based monomer, or a carboxyl/hydroxyl-containing acrylate-based monomer. The separate or combined introduction of carboxyl and hydroxyl functional groups is conducive to enhancing the synergistic crosslinking reaction between the acrylate-based polymer and the auxiliary agent A and the auxiliary agent B, such that the crosslinking density of the electrically peelable composition is significantly improved, and the adhesive retention of the adhesive layer formed by the electrically peelable composition is improved.

It should be noted that the alkyl (meth)acrylate containing an alkyl group with 1-14 carbon atoms as the principal unit in the examples of the present disclosure may account for 60-95 wt % of all monomers of the acrylate-based polymer in a weight fraction; and the functional unit, as a main contributing unit for the acrylate-based polymer to undergo a crosslinking reaction with the auxiliary agent A and the auxiliary agent B, may account for 5-30 wt % of all monomers of the acrylate-based polymer in the weight fraction.

Further, in the alkyl (meth)acrylate containing an alkyl group with 1-14 carbon atoms in the examples of the present disclosure, alkyl (meth)acrylate refers to methyl acrylate or acrylate. For example, the alkyl (meth)acrylate containing an alkyl group with 1-14 carbon atoms may be methyl(meth)acrylate, ethyl(meth)acrylate, n-propyl(meth)acrylate, isopropyl(meth)acrylate, n-butyl(meth)acrylate, sec-butyl(meth)acrylate, tert-butyl(meth)acrylate, n-octyl(meth)acrylate, iso-octyl(meth)acrylate, 2-ethylhexyl(meth)acrylate, isononyl(meth)acrylate, dodecyl(meth)acrylate, etc., and the above alkyl (meth)acrylate may be used alone or in combination of two or more for preparing the acrylate-based polymer.

Further, in the functional unit of the examples of the present disclosure, the carboxyl-containing acrylate-based monomer may be a carboxyl-containing monomer such as acrylic acid, methacrylic acid, or carboxyethyl acrylate; the hydroxyl-containing acrylate-based monomer may be a hydroxyl-containing monomer such as 2-hydroxyethyl(meth)acrylate, 2-hydroxypropyl(meth)acrylate, 4-hydroxybutyl(meth)acrylate, 6-hydroxyhexyl(meth)acrylate, and (4-hydroxymethylcyclohexyl)methyl acrylate; and the above monomers listed for the functional unit may be used alone or in combination of two or more for preparing the acrylate-based polymer.

In some examples, when the initiator is a thermal polymerization initiator, a mass ratio of the principal unit to the functional unit is (70-95):(5-30); when the mass ratio of the principal unit to the functional unit is within this range, polymerization may be performed under the action of the thermal polymerization initiator, and the prepared acrylate-based polymer fully crosslinks with the auxiliary agent A and the auxiliary agent B to improve the crosslinking density of the electrically peelable composition, such that the electrically peelable composition has high cohesion, and the adhesive retention of the adhesive layer formed by the electrically peelable composition is further improved.

In some examples, when the initiator is a photoinitiator, raw materials of the acrylate-based polymer further include a multifunctional UV monomer, which may account for 0.1-10 wt % of all monomers of the acrylate-based polymer in the weight fraction; and the introduction of the multifunctional UV monomer facilitates synergistic crosslinking with the UV-curable resin of the auxiliary agent B under the action of the auxiliary agent A, improves the crosslinking density of the electrically peelable composition, and greatly improves the cohesive strength of the electrically peelable composition, such that the adhesive retention of the adhesive layer formed by the electrically peelable composition is significantly improved. Additionally, the introduction of the multifunctional UV monomer also facilitates improving the weather resistance of the electrically peelable composition, such that the formed adhesive layer has better adhesive retention.

Further, the multifunctional UV monomer in the examples of the present disclosure may be polyethylene glycol di(meth)acrylate, diethylene glycol di(meth)acrylate, tetraethylene glycol di(meth)acrylate, neopentyl glycol di(meth)acrylate, 1,6-hexanediol di(meth)acrylate, trimethylolpropane tri(meth)acrylate, pentaerythritol tri(meth)acrylate, or dipentaerythritol hexa(meth)acrylate, and these multifunctional UV monomers may be used alone or in combination of two or more for preparing the acrylate-based polymer.

In some examples, a mass ratio of the principal unit to the functional unit and to the multifunctional UV monomer is (60-95):(3-30):(2-10), preferably (60-85):(10-30):(5-10). Within the above mass ratio range, the principal unit, the functional unit, and the multifunctional UV monomer may be polymerized under the action of the photoinitiator, and the prepared acrylate-based polymer has the characteristics of both the functional unit and the multifunctional UV monomer, and is capable of fully crosslinking with the auxiliary agent A and the auxiliary agent B, thereby further improving the cohesion of the electrically peelable composition, and inhibiting the loss of crosslinking density caused by the introduction of the ionic liquid and other non-reactive components.

In some examples, to provide a polymerization reaction environment for monomers such as the principal unit and the functional unit, the raw materials of the acrylate-based polymer further include a polymerization solvent, and the polymerization solvent includes one or more of an aliphatic hydrocarbon, an ester compound, and an aromatic hydrocarbon; and the above substances as polymerization solvents all provide the required reaction environment for the polymerization of monomers such as the principal unit and the functional unit, such that the monomers stably form the acrylate-based polymer under the action of the initiator.

In some examples, the thermal polymerization initiator includes any one of azo polymerization initiators such as 2,2′-azobisisobutyronitrile, 2,2′-azobis(2-methylpropionamidine)disulfide, 2,2′-azobis(4-methoxy-2,4-dimethylvaleronitrile), 2,2′-azobis(2-methylbutyronitrile), 2,2′-azobis(2,4,4-trimethylpentane), 2,2′-azobis(2,4-dimethylvaleronitrile), 1, 1′-azobis(cyclohexane-1-carbonitrile), dimethyl-2,2′-azobis(2-methylpropanoate), 2,2′-azobis [2-methyl-N-(phenylmethyl) propionamidine]dihydrochloride, 2,2′-azobis [2-(3,4,5,6-tetrahydropyrimidin-2-yl) propane]dihydrochloride, or 2,2′-azobis [2-(2-imidazolin-2-yl) propane], or any one of persulfate compounds such as potassium persulfate or ammonium persulfate; and each of the above substances as a thermal polymerization initiator is capable of initiating the polymerization reaction of the principal unit and the functional unit, such that the principal unit and the functional unit are polymerized to form the acrylate-based polymer.

In some examples, the photoinitiator includes any one of Type I photoinitiators such as hydroxypropiophenone, alkylaminoacetophenone, benzoin ether, or phosphine oxide, or any one of Type II initiators such as benzophenone, substituted benzophenone, anthraquinone, benzoylformate, camphorquinone, or thioxanthone. Each of the above substances as a photoinitiator is capable of initiating the polymerization reaction of the principal unit, the functional unit, and the multifunctional UV monomer, such that the principal unit, the functional unit, and the multifunctional UV monomer are polymerized to form the acrylate-based polymer.

In another example of the present disclosure, a method for preparing the electrically peelable composition is provided, including:
step of preparing an acrylate-based polymer: mixing a principal unit, a functional unit, and a polymerization solvent with a thermal polymerization initiator in a predetermined ratio for reaction to obtain an acrylate-based polymer A; or mixing a principal unit, a functional unit, a multifunctional UV monomer, and a polymerization solvent with a photoinitiator in a predetermined ratio for reaction to obtain an acrylate-based polymer B; and
step of preparing an electrically peelable composition: mixing the acrylate-based polymer A or the acrylate-based polymer B with remaining components in a predetermined ratio for reaction to obtain an electrically peelable composition.

It can be understood that the acrylate-based polymer in this example may be prepared by solution polymerization or UV photopolymerization, where when the solution polymerization is employed, the step of preparing an acrylate-based polymer is to mix the principal unit, the functional unit, and the polymerization solvent with the thermal polymerization initiator in a predetermined ratio for reaction, and during the preparation process, the polymerization solvent is capable of dissolving the principal unit and the functional unit, such that the two units are in full contact with each other in a reaction system, and the acrylate-based polymer A is obtained through the polymerization reaction under the action of the thermal polymerization initiator; and when the UV photopolymerization is employed, the step of preparing an acrylate-based polymer is to mix the principal unit, the functional unit, the multifunctional UV monomer, and the polymerization solvent with the photoinitiator in a predetermined ratio for reaction, and the polymerization solvent is capable of dissolving the principal unit, the functional unit, and the multifunctional UV monomer, such that all monomers are in full contact with each other in the reaction system, and the acrylate-based polymer B is obtained through the polymerization reaction under the action of the photoinitiator.

In the step of preparing an electrically peelable composition, the acrylate-based polymer A or the acrylate-based polymer B is uniformly mixed with remaining components in a predetermined ratio and degassed to obtain a high-quality electrically peelable composition.

In some examples, the step of preparing an acrylate-based polymer includes: mixing a monomer mixture A composed of a principal unit and a functional unit with a polymerization solvent at a mass ratio of 1:(1-9), and adding a thermal polymerization initiator accounting for 0.2-1% by mass of the monomer mixture A for a heating reaction to obtain an acrylate-based polymer A.

In some preferred examples, when the solution polymerization is employed, the step of preparing an acrylate-based polymer includes: forming the monomer mixture A from the principal unit and the functional unit at a mass ratio of (70-95):(5-30); placing the monomer mixture A and the polymerization solvent into a reaction vessel at a mass ratio of 1:(1-9), and stirring under nitrogen protection for 0.5-2 h until all materials are completely dissolved; and adding a thermal polymerization initiator accounting for 0.2-1% by mass of the monomer mixture, heating to 60-90° C. while stirring for reaction for 4-10 h to obtain the acrylate-based polymer A.

In some examples, the step of preparing an acrylate-based polymer specifically includes: mixing a monomer mixture B composed of a principal unit, a functional unit, and a multifunctional UV monomer with a polymerization solvent at a mass ratio of 1:(1-9), and adding a photoinitiator accounting for 1-5% by mass of the monomer mixture B for a reaction under UV irradiation to obtain an acrylate-based polymer B.

In some preferred examples, when the UV photopolymerization is employed, the step of preparing an acrylate-based polymer includes: forming a monomer mixture B from a principal unit, a functional unit, and a multifunctional UV monomer at a mass ratio of (60-95):(3-30):(2-10); placing the monomer mixture B and a polymerization solvent into a reaction vessel at a mass ratio of 1:(1-9), adding a photoinitiator accounting for 1-5% by mass of the monomer mixture, and stirring under nitrogen protection for 0.5-2 h until all materials are completely dissolved; and irradiating the reaction vessel with 365 nm UV-LED for 10-30 min while stirring to obtain an acrylate-based polymer B.

In some embodiments, in the step of preparing an electrically peelable composition, when an acrylate-based polymer B is mixed with remaining components in a predetermined ratio for reaction, the remaining components further include a photoinitiator accounting for 1-5% of a total mass of the acrylate-based polymer B, and further adding the photoinitiator accounting for 1-5% of a total mass of the acrylate-based polymer B in the step of preparing an electrically peelable composition ensures that the electrically peelable composition more easily forms an adhesive layer during curing and film formation.

In another example of the present disclosure, an adhesive product is provided, including a substrate, and an adhesive layer formed by covering a surface of the substrate with the above electrically peelable composition or the electrically peelable composition prepared by the above preparation method.

It should be noted that the substrate of the adhesive product is preferably a conductive object, and for example, the conductive object may specifically be a conductive adherend, a conductive auxiliary material, a conductive substrate, or a conductive fixed object, which facilitates the conduction of current to the adhesive layer formed by the electrically peelable composition, such that the adhesive layer is easily peeled from the adherend.

Additionally, the adhesive product provided by the examples of the present disclosure may be an adhesive sheet or an adhesive tape; and taking the adhesive product as an adhesive tape as an example, the preparation process includes: the above electrically peelable composition may be coated on a surface of a release-treated polyester film, and dried to form an adhesive layer and an adhesive tape, the adhesive tape may be adhered in the form of contact with a conductive object, and when a voltage of 12 V is applied to the adhesive layer formed by the electrically peelable composition for 30 sec, the adhesive layer may be peeled from the directly adhered conductive object without residual adhesive.

The implementation solutions of the present disclosure will be described in detail below with reference to specific examples, but those skilled in the art will understand that the following examples are only used to illustrate the present disclosure and should not be construed as limiting the scope of the present disclosure. If specific conditions are not specified in the examples, conventional conditions or conditions recommended by the manufacturer shall prevail. If the manufacturers of reagents or instruments used are not specified, they are all conventional products commercially available from the market.

### Example 1

Steps of preparing an acrylate-based polymer: A monomer mixture composed of 75 parts of n-butyl acrylate, 20 parts of methyl acrylate, and 5 parts of 2-hydroxyethyl acrylate, and 150 parts of a polymerization solvent were placed in a four-necked flask, and a resulting mixture was stirred under nitrogen protection for 1 h until all materials were completely dissolved, where the polymerization solvent was composed of 135 parts of ethyl acetate and 15 parts of toluene; and then 0.3 parts of a thermal polymerization initiator azobisisobutyronitrile (AIBN) were added, and a resulting mixture was heated to 80-85° C. while stirring for reaction for 5 h to obtain an acrylate-based polymer with a solid content of 40%.

Steps of preparing an electrically peelable composition: The above acrylate-based polymer was mixed with 1 part of an isocyanate-based crosslinking agent TG-1, 5 parts of an ionic liquid EMIBF4, and 20 parts of a reactive tackifying resin (resin of Formula II), and a resulting mixture was dispersed at high speed with a high-speed mixer at room temperature for 5 min, and degassed to obtain an adhesive composition A1.

### Example 2

Steps of preparing an acrylate-based polymer: A monomer mixture composed of 85 parts of n-butyl acrylate, 10 parts of acrylic acid, and 5 parts of 2-hydroxyethyl acrylate, and 150 parts of a polymerization solvent were placed in a four-necked flask, and a resulting mixture was stirred under nitrogen protection for 1 h until all materials were completely dissolved, where the polymerization solvent was composed of 135 parts of ethyl acetate and 15 parts of toluene; and then 0.3 parts of a thermal polymerization initiator azobisisobutyronitrile (AIBN) were added, and a resulting mixture was heated to 80-85° C. while stirring for reaction for 5 h to obtain an acrylate-based polymer with a solid content of 40%.

Steps of preparing an electrically peelable composition: The above acrylate-based polymer was mixed with 1 part of an epoxy-based crosslinking agent TG-6, 5 parts of an ionic liquid EMIBF4, and 20 parts of a reactive tackifying resin ARDYME R-9520, and a resulting mixture was dispersed at high speed with a high-speed mixer at room temperature for 5 min, and degassed to obtain an adhesive composition A2.

### Example 3

Steps of preparing an acrylate-based polymer: A monomer mixture composed of 80 parts of n-butyl acrylate, 10 parts of acrylic acid, 5 parts of 2-hydroxyethyl acrylate, and 5 parts of 1,6-hexanediol diacrylate, 150 parts of a polymerization solvent, and 3 parts of 2-hydroxy-2-methyl-1-phenyl-1-propanone were placed in a four-necked flask, and a resulting mixture was stirred under nitrogen protection for 1 h until all materials were completely dissolved, where the polymerization solvent was composed of 150 parts of ethyl acetate; and then irradiating with 365 nm UV-LED was performed for 20 min while stirring to obtain an acrylate-based polymer with a solid content of 40%.

Steps of preparing an electrically peelable composition: The above acrylate-based polymer was mixed with 2 parts of polyurethane acrylate CN007, 5 parts of an ionic liquid AS-110, 20 parts of a reactive tackifying resin (resin of Formula I), and 3 parts of hydroxycyclohexyl phenyl ketone, and a resulting mixture was dispersed at high speed with a high-speed mixer at room temperature for 5 min, and degassed to obtain an adhesive composition A3.

### Example 4

Steps of preparing an acrylate-based polymer: A monomer mixture composed of 60 parts of n-butyl acrylate, 20 parts of methyl acrylate, 15 parts of 2-hydroxyethyl acrylate, and 5 parts of polyethylene glycol diacrylate, 150 parts of a polymerization solvent, and 3 parts of 2-hydroxy-2-methyl-1-phenyl-1-propanone were placed in a four-necked flask, and a resulting mixture was stirred under nitrogen protection for 1 h until all materials were completely dissolved, where the polymerization solvent was composed of 150 parts of ethyl acetate; and then irradiating with 365 nm UV-LED was performed for 20 min while stirring to obtain an acrylate-based polymer with a solid content of 40%.

Steps of preparing an electrically peelable composition: The above acrylate-based polymer was mixed with 2 parts of polyurethane acrylate 6145-100, 5 parts of an ionic liquid EMIBF4, 20 parts of a reactive tackifying resin (resin of Formula II), and 3 parts of hydroxycyclohexyl phenyl ketone, and a resulting mixture was dispersed at high speed with a high-speed mixer at room temperature for 5 min, and degassed to obtain an adhesive composition A4.

### Example 5

Steps of preparing an acrylate-based polymer: A monomer mixture composed of 70 parts of n-butyl acrylate, 10 parts of acrylic acid, 10 parts of 2-hydroxyethyl acrylate, 5 parts of 1,6-hexanediol diacrylate, and 5 parts of polyethylene glycol diacrylate, 150 parts of a polymerization solvent, and 3 parts of 2-hydroxy-2-methyl-1-phenyl-1-propanone were placed in a four-necked flask, and a resulting mixture was stirred under nitrogen protection for 1 h until all materials were completely dissolved, where the polymerization solvent was composed of 150 parts of ethyl acetate; and then then irradiating with 365 nm UV-LED was performed for 20 min while stirring to obtain an acrylate-based polymer with a solid content of 40%.

Steps of preparing an electrically peelable composition: The above acrylate-based polymer was mixed with 2 parts of polyurethane acrylate 6145-100, 5 parts of an ionic liquid EMIBF4, 20 parts of a reactive tackifying resin (resin of Formula III), and 3 parts of hydroxycyclohexyl phenyl ketone, and a resulting mixture was dispersed at high speed with a high-speed mixer at room temperature for 5 min, and degassed to obtain an adhesive composition A5.

### Example 6

Steps of preparing an acrylate-based polymer: A monomer mixture composed of 60 parts of n-butyl acrylate, 20 parts of methyl acrylate, 15 parts of 2-hydroxyethyl acrylate, and 5 parts of polyethylene glycol diacrylate, 150 parts of a polymerization solvent, and 3 parts of 2-hydroxy-2-methyl-1-phenyl-1-propanone were placed in a four-necked flask, and a resulting mixture was stirred under nitrogen protection for 1 h until all materials were completely dissolved, where the polymerization solvent was composed of 150 parts of ethyl acetate; and then irradiating with 365 nm UV-LED was performed for 20 min while stirring to obtain an acrylate-based polymer with a solid content of 40%.

Steps of preparing an electrically peelable composition: The above acrylate-based polymer was mixed with 0.5 parts of an isocyanate-based crosslinking agent TG-1, 1.5 parts of polyurethane acrylate 6145-100, 10 parts of an ionic liquid AS-110, 20 parts of a reactive tackifying resin (resin of Formula II), and 3 parts of hydroxycyclohexyl phenyl ketone, and a resulting mixture was dispersed at high speed with a high-speed mixer at room temperature for 5 min, and degassed to obtain an adhesive composition A6.

### Example 7

Steps of preparing an acrylate-based polymer: A monomer mixture composed of 60 parts of n-butyl acrylate, 20 parts of methyl acrylate, 15 parts of 2-hydroxyethyl acrylate, and 5 parts of polyethylene glycol diacrylate, 150 parts of a polymerization solvent, and 3 parts of 2-hydroxy-2-methyl-1-phenyl-1-propanone were placed in a four-necked flask, and a resulting mixture was stirred under nitrogen protection for 1 h until all materials were completely dissolved, where the polymerization solvent was composed of 150 parts of ethyl acetate; and then irradiating with 365 nm UV-LED was performed for 20 min while stirring to obtain an acrylate-based polymer with a solid content of 40%.

Steps of preparing an electrically peelable composition: The above acrylate-based polymer was mixed with 2 parts of polyurethane acrylate 6145-100, 20 parts of an ionic liquid EMIBF4, 20 parts of a reactive tackifying resin (resin of Formula II), and 3 parts of hydroxycyclohexyl phenyl ketone, and a resulting mixture was dispersed at high speed with a high-speed mixer at room temperature for 5 min, and degassed to obtain an adhesive composition A7.

### Example 8

Steps of preparing an acrylate-based polymer: A monomer mixture composed of 80 parts of n-butyl acrylate, 10 parts of acrylic acid, 5 parts of 2-hydroxyethyl acrylate, and 5 parts of 1,6-hexanediol diacrylate, 150 parts of a polymerization solvent, and 3 parts of 2-hydroxy-2-methyl-1-phenyl-1-propanone were placed in a four-necked flask, and a resulting mixture was stirred under nitrogen protection for 1 h until all materials were completely dissolved, where the polymerization solvent was composed of 150 parts of ethyl acetate; and then irradiating with 365 nm UV-LED was performed for 20 min while stirring to obtain an acrylate-based polymer with a solid content of 40%.

Steps of preparing an electrically peelable composition: The above acrylate-based polymer was mixed with 2 parts of polyurethane acrylate CN007, 5 parts of an ionic liquid AS-110, 30 parts of a reactive tackifying resin (resin of Formula I), and 3 parts of hydroxycyclohexyl phenyl ketone, and a resulting mixture was dispersed at high speed with a high-speed mixer at room temperature for 5 min, and degassed to obtain an adhesive composition A8.

### Example 9

Steps of preparing an acrylate-based polymer: A monomer mixture composed of 80 parts of n-butyl acrylate, 10 parts of acrylic acid, 5 parts of 2-hydroxyethyl acrylate, and 5 parts of 1,6-hexanediol diacrylate, 150 parts of a polymerization solvent, and 3 parts of 2-hydroxy-2-methyl-1-phenyl-1-propanone were placed in a four-necked flask, and a resulting mixture was stirred under nitrogen protection for 1 h until all materials were completely dissolved, where the polymerization solvent was composed of 150 parts of ethyl acetate; and then irradiating with 365 nm UV-LED was performed for 20 min while stirring to obtain an acrylate-based polymer with a solid content of 40%.

Steps of preparing an electrically peelable composition: The above acrylate-based polymer was mixed with 2 parts of polyurethane acrylate CN007, 5 parts of an ionic liquid EMIBF4, 10 parts of a reactive tackifying resin (resin of Formula I), and 3 parts of hydroxycyclohexyl phenyl ketone, and a resulting mixture was dispersed at high speed with a high-speed mixer at room temperature for 5 min, and degassed to obtain an adhesive composition A9.

### Comparative Example 1

Steps of preparing an acrylate-based polymer: A monomer mixture composed of 85 parts of n-butyl acrylate, 10 parts of acrylic acid, and 5 parts of 2-hydroxyethyl acrylate, and 150 parts of a polymerization solvent were placed in a four-necked flask, and a resulting mixture was stirred under nitrogen protection for 1 h until all materials were completely dissolved, where the polymerization solvent was composed of 135 parts of ethyl acetate and 15 parts of toluene; and then 0.3 parts of a thermal polymerization initiator azobisisobutyronitrile (AIBN) were added, and a resulting mixture was heated to 80-85° C. while stirring for reaction for 5 h to obtain an acrylate-based polymer with a solid content of 40%.

Steps of preparing an electrically peelable composition: The above acrylate-based polymer was mixed with 1 part of an epoxy-based crosslinking agent TG-6, 5 parts of an ionic liquid EMIBF4, and 20 parts of a non-reactive tackifying resin GA-85, and a resulting mixture was dispersed at high speed with a high-speed mixer at room temperature for 5 min, and degassed to obtain an adhesive composition B1.

### Comparative Example 2

Steps of preparing an acrylate-based polymer: A monomer mixture composed of 60 parts of n-butyl acrylate, 20 parts of methyl acrylate, 15 parts of 2-hydroxyethyl acrylate, and 5 parts of polyethylene glycol diacrylate, 150 parts of a polymerization solvent, and 3 parts of 2-hydroxy-2-methyl-1-phenyl-1-propanone were placed in a four-necked flask, and a resulting mixture was stirred under nitrogen protection for 1 h until all materials were completely dissolved, where the polymerization solvent was composed of 150 parts of ethyl acetate; and then irradiating with 365 nm UV-LED was performed for 20 min while stirring to obtain an acrylate-based polymer with a solid content of 40%.

Steps of preparing an electrically peelable composition: The above acrylate-based polymer was mixed with 5 parts of an ionic liquid AS-110, 20 parts of a non-reactive tackifying resin GA-85, and 3 parts of hydroxycyclohexyl phenyl ketone, and a resulting mixture was dispersed at high speed with a high-speed mixer at room temperature for 5 min, and degassed to obtain an adhesive composition B2.

### Comparative Example 3

Steps of preparing an acrylate-based polymer: A monomer mixture composed of 60 parts of n-butyl acrylate, 20 parts of methyl acrylate, 15 parts of 2-hydroxyethyl acrylate, and 5 parts of polyethylene glycol diacrylate, 150 parts of a polymerization solvent, and 3 parts of 2-hydroxy-2-methyl-1-phenyl-1-propanone were placed in a four-necked flask, and a resulting mixture was stirred under nitrogen protection for 1 h until all materials were completely dissolved, where the polymerization solvent was composed of 150 parts of ethyl acetate; and then irradiating with 365 nm UV-LED was performed for 20 min while stirring to obtain an acrylate-based polymer with a solid content of 40%.

Steps of preparing an electrically peelable composition: The above acrylate-based polymer was mixed with 2 parts of polyurethane acrylate 6145-100, 5 parts of an ionic liquid EMIBF4, 5 parts of a reactive tackifying resin (resin of Formula II), and 3 parts of hydroxycyclohexyl phenyl ketone, and a resulting mixture was dispersed at high speed with a high-speed mixer at room temperature for 5 min, and degassed to obtain an adhesive composition B3.

### Comparative Example 4

Steps of preparing an acrylate-based polymer: A monomer mixture composed of 60 parts of n-butyl acrylate, 20 parts of methyl acrylate, 15 parts of 2-hydroxyethyl acrylate, and 5 parts of polyethylene glycol diacrylate, 150 parts of a polymerization solvent, and 3 parts of 2-hydroxy-2-methyl-1-phenyl-1-propanone were placed in a four-necked flask, and a resulting mixture was stirred under nitrogen protection for 1 h until all materials were completely dissolved, where the polymerization solvent was composed of 150 parts of ethyl acetate; and then irradiating with 365 nm UV-LED was performed for 20 min while stirring to obtain an acrylate-based polymer with a solid content of 40%.

Steps of preparing an electrically peelable composition: The above acrylate-based polymer was mixed with 2 parts of polyurethane acrylate 6145-100, 5 parts of an ionic liquid EMIBF4, 40 parts of a reactive tackifying resin (resin of Formula II), and 3 parts of hydroxycyclohexyl phenyl ketone, and a resulting mixture was dispersed at high speed with a high-speed mixer at room temperature for 5 min, and degassed to obtain an adhesive composition B4.

### Comparative Example 5

Steps of preparing an acrylate-based polymer: A monomer mixture composed of 60 parts of n-butyl acrylate, 20 parts of methyl acrylate, 15 parts of 2-hydroxyethyl acrylate, and 5 parts of polyethylene glycol diacrylate, 150 parts of a polymerization solvent, and 3 parts of 2-hydroxy-2-methyl-1-phenyl-1-propanone were placed in a four-necked flask, and a resulting mixture was stirred under nitrogen protection for 1 h until all materials were completely dissolved, where the polymerization solvent was composed of 150 parts of ethyl acetate; and then irradiating with 365 nm UV-LED was performed for 20 min while stirring to obtain an acrylate-based polymer with a solid content of 40%.

Steps of preparing an electrically peelable composition: The above acrylate-based polymer was mixed with 2 parts of polyurethane acrylate 6145-100, 5 parts of an ionic liquid AS-110, and 3 parts of hydroxycyclohexyl phenyl ketone, and a resulting mixture was dispersed at high speed with a high-speed mixer at room temperature for 5 min, and degassed to obtain an adhesive composition B5.

### Comparative Example 6

Steps of preparing an acrylate-based polymer: A monomer mixture composed of 60 parts of n-butyl acrylate, 20 parts of methyl acrylate, 15 parts of 2-hydroxyethyl acrylate, and 5 parts of polyethylene glycol diacrylate, 150 parts of a polymerization solvent, and 3 parts of 2-hydroxy-2-methyl-1-phenyl-1-propanone were placed in a four-necked flask, and a resulting mixture was stirred under nitrogen protection for 1 h until all materials were completely dissolved, where the polymerization solvent was composed of 150 parts of ethyl acetate; and then irradiating with 365 nm UV-LED was performed for 20 min while stirring to obtain an acrylate-based polymer with a solid content of 40%.

Steps of preparing an electrically peelable composition: The above acrylate-based polymer was mixed with 5 parts of an ionic liquid EMIBF4, 20 parts of a reactive tackifying resin (resin of Formula II), and 3 parts of hydroxycyclohexyl phenyl ketone, and a resulting mixture was dispersed at high speed with a high-speed mixer at room temperature for 5 min, and degassed to obtain an adhesive composition B6.

It should be noted that n-butyl acrylate and methyl acrylate among alkyl (meth)acrylate-based monomers used in the above Examples and Comparative Examples were all sourced from Zhejiang Formosa Plastics Optoelectronic Technology Co., Ltd.; acrylic acid among carboxyl-containing acrylate-based monomers was sourced from Wanhua Chemical; 2-hydroxyethyl acrylate among the hydroxyl-containing acrylate-based monomers was sourced from Jiangsu Jurong Chemical Co., Ltd.; 1,6-hexanediol diacrylate and polyethylene glycol diacrylate among multifunctional UV monomers were sourced from Eternal Chemical; 2-hydroxy-2-methyl-1-phenyl-1-propanone (a photoinitiator 1173) and hydroxycyclohexyl phenyl ketone (a photoinitiator 184) among initiators were all commercially available photoinitiators; among auxiliary agents B, an isocyanate-based crosslinking agent TG-1 and an epoxy-based crosslinking agent TG-6 were both sourced from Jiangxi Tayilai Polymer Materials Co., Ltd., polyurethane acrylate CN007 was sourced from Sartomer Chemical, and polyurethane acrylate 6145-100 was sourced from Eternal Chemical; the ionic liquid EMIBF4 was sourced from Kanto Chemical Co., Inc., and the ionic liquid AS-110 was sourced from Dai-ichi Kogyo Seiyaku Co., Ltd.; and among auxiliary agents A, a reactive tackifying resin ARDYME R-9520 (rosin-based carboxyl-containing tackifying resin) was sourced from Arakawa Chemical, a reactive tackifying resin (resin of Formula I) was sourced from Yiqing Chemical TSR-6000, a non-reactive tackifying resin GA-85 was sourced from Arakawa Chemical, and a reactive tackifying resin (resin of Formula II) and a reactive tackifying resin (resin of Formula III) were self-made, where the resin of Formula II was obtained by modifying disproportionated rosin (R in the resin of Formula II is an acryloyloxy group), and the resin of Formula III was obtained by modifying p-tert-octylphenol formaldehyde resin.

Component information of the electrically peelable compositions A1-B6 in the above Examples and Comparative Examples is summarized in Table 1 below:

TABLE 1
Component information statistics of electrically peelable compositions

| Components | | A1 | A2 | A3 | A4 | A5 | A6 | A7 | A8 | A9 | B1 | B2 | B3 | B4 | B5 | B6 |
|---|---|---|---|---|---|---|---|---|---|---|---|---|---|---|---|---|
| Alkyl | n-butyl | 75 | 85 | 80 | 60 | 70 | 60 | 60 | 80 | 80 | 85 | 60 | 60 | 60 | 60 | 60 |
| (meth)acrylate- | acrylate | | | | | | | | | | | | | | | |
| based | Methyl | 20 | / | / | 20 | / | 20 | 20 | / | / | / | 20 | 20 | 20 | 20 | 20 |
| monomers | acrylate | | | | | | | | | | | | | | | |
| Carboxyl-containing | Acrylic acid | / | 10 | 10 | / | 10 | / | / | 10 | 10 | 10 | / | / | / | / | / |
| acrylate-based | | | | | | | | | | | | | | | | |
| monomers | | | | | | | | | | | | | | | | |
| Hydroxyl-containing | 2-hydroxyethyl | 5 | 5 | 5 | 15 | 10 | 15 | 15 | 5 | 5 | 5 | 15 | 15 | 15 | 15 | 15 |
| acrylate-based | acrylate | | | | | | | | | | | | | | | |
| monomers | | | | | | | | | | | | | | | | |
| Multifunctional | 1,6-hexanediol | / | / | 5 | / | 5 | / | / | 5 | 5 | / | / | / | / | / | / |
| UV | diacrylate | | | | | | | | | | | | | | | |
| monomers | Polyethylene | / | / | / | 5 | 5 | 5 | 5 | / | / | / | 5 | 5 | 5 | 5 | 5 |
| | glycol | | | | | | | | | | | | | | | |
| | diacrylate | | | | | | | | | | | | | | | |
| Solvents | Ethyl acetate | 135 | 135 | 150 | 150 | 150 | 150 | 150 | 150 | 150 | 135 | 150 | 150 | 150 | 150 | 150 |
| | Toluene | 15 | 15 | / | / | / | / | / | / | / | 15 | / | / | / | / | / |
| Initiators | Azobisiso- | 0.3 | 0.3 | / | / | / | / | / | / | / | 0.3 | / | / | / | / | / |
| | butyronitrile | | | | | | | | | | | | | | | |
| | (AIBN) | | | | | | | | | | | | | | | |
| | 2-hydroxy-2- | / | / | 3 | 3 | 3 | 3 | 3 | 3 | 3 | / | 3 | 3 | 3 | 3 | 3 |
| | methyl-1-phenyl- | | | | | | | | | | | | | | | |
| | 1-propanone | | | | | | | | | | | | | | | |
| | Hydroxycyclohexyl | / | / | 3 | 3 | 3 | 3 | 3 | 3 | 3 | / | 3 | 3 | 3 | 3 | 3 |
| | phenyl | | | | | | | | | | | | | | | |
| | ketone | | | | | | | | | | | | | | | |
| Auxiliary | Isocyanate- | 1 | / | / | / | / | 0.5 | / | / | / | / | / | / | / | / | / |
| agents B | based | | | | | | | | | | | | | | | |
| | crosslinking | | | | | | | | | | | | | | | |
| | agent TG-1 | | | | | | | | | | | | | | | |
| | Epoxy-based | / | 1 | / | / | / | / | / | / | / | 1 | / | / | / | / | / |
| | crosslinking | | | | | | | | | | | | | | | |
| | agent TG-6 | | | | | | | | | | | | | | | |
| | Polyurethane | / | / | 2 | / | / | / | / | 2 | 2 | / | / | / | / | / | / |
| | acrylate | | | | | | | | | | | | | | | |
| | CN007 | | | | | | | | | | | | | | | |
| | Polyurethane | / | / | / | 2 | 2 | 1.5 | 2 | / | / | / | / | 2 | 2 | 2 | / |
| | acrylate | | | | | | | | | | | | | | | |
| | 6145-100 | | | | | | | | | | | | | | | |
| Ionic liquids | EMIBF4 | 5 | 5 | / | 5 | 5 | / | 20 | / | 5 | 5 | / | 5 | 5 | / | 5 |
| | AS-110 | / | / | 5 | / | / | 10 | / | 5 | / | / | 5 | / | / | 5 | / |
| Auxiliary | Reactive | / | 20 | / | / | / | / | / | / | / | / | / | / | / | / | / |
| agents A | tackifying | | | | | | | | | | | | | | | |
| | resin | | | | | | | | | | | | | | | |
| | ARDYME | | | | | | | | | | | | | | | |
| | R-9520 | | | | | | | | | | | | | | | |
| | Reactive | 20 | / | / | 20 | / | 20 | 20 | / | / | / | / | 5 | 40 | / | 20 |
| | tackifying | | | | | | | | | | | | | | | |
| | resin (resin of | | | | | | | | | | | | | | | |
| | Formula II) | | | | | | | | | | | | | | | |
| | Reactive | / | / | 20 | / | / | / | / | 30 | 10 | / | / | / | / | / | / |
| | tackifying | | | | | | | | | | | | | | | |
| | resin (resin of | | | | | | | | | | | | | | | |
| | Formula I) | | | | | | | | | | | | | | | |
| | Reactive | / | / | / | / | 20 | / | / | / | / | / | / | / | / | / | / |
| | tackifying | | | | | | | | | | | | | | | |
| | resin (resin of | | | | | | | | | | | | | | | |
| | Formula III) | | | | | | | | | | | | | | | |
| | Non-reactive | / | / | / | / | / | / | / | / | 20 | 20 | / | / | / | / | / |
| | tackifying 1 | | | | | | | | | | | | | | | |
| | resin GA-85 | | | | | | | | | | | | | | | |

To validate the performance of the electrically peelable compositions A1-B6 prepared in the Examples and Comparative Examples, each of the electrically peelable compositions A1-B6 was made into an adhesive product, with the preparation process as follows:

The electrically peelable compositions A1, A2, and B1 were respectively coated on a surface of a release-treated polyethylene terephthalate (PET) film (with a thickness of 50 μm), the film was then dried at 80° C. for 3 min to obtain an electrically peelable adhesive layer with a dry film thickness of 50 μm, then, the adhesive layer was cured at 40° C. for 3 d, and finally a release film was placed on a surface of the adhesive layer to obtain an adhesive product. Additionally,

the electrically peelable compositions A3-A8 and B2-B6 were respectively coated on a surface of a release-treated polyethylene terephthalate (PET) film (with a thickness of 50 μm), then the film was cured under 365 nm UV-LED irradiation for 3 min to obtain an electrically peelable adhesive layer with a dry film thickness of 50 μm, and then a release film was placed on a surface of the adhesive layer to obtain an adhesive product.

The performance of the adhesive products prepared from the electrically peelable compositions A1-B6 in the Examples and Comparative Examples was tested respectively. Taking the test process of any adhesive product derived from the electrically peelable compositions A1-B6 as an example, test methods include:

Initial peeling strength test: 3 samples with a size of 25 mm×100 mm were prepared; one release film was peeled off, and one pressure-sensitive adhesive surface was laminated to a non-release-treated PET film to prevent generation of bubbles and wrinkles; a 2 kg roller was used to roll back and forth 3 times at a speed of 300 mm/min; the other release film was peeled off, and the other pressure-sensitive adhesive surface was laminated to a steel plate to prevent generation of bubbles and wrinkles; the 2 kg roller was used to roll back and forth 3 times at a speed of 300 mm/min, followed by standing at room temperature for 30 min; a special test tape was attached to a back side of the PET film; an end of the steel plate is fixed on a lower fixture of a tensile tester and kept perpendicular to a horizontal plane, to achieve load zeroing; peeling strength at 2180° was measured at a test speed of 300 mm/min; and average peeling strength at a peeling length of 60 mm after peeling strength stabilization was calculated.

Peeling strength test after electrification: 3 samples with a size of 25 mm×100 mm were prepared; one release film was peeled off, and one pressure-sensitive adhesive surface was laminated to aluminum foil to prevent generation of bubbles and wrinkles; a 2 kg roller was used to roll back and forth 3 times at a speed of 300 mm/min, and sample strips were cut from the aluminum foil; the other release film was peeled off, and the other pressure-sensitive adhesive surface was laminated to a steel plate to prevent generation of bubbles and wrinkles; the 2 kg roller was used to roll back and forth 3 times at a speed of 300 mm/min, followed by standing at room temperature for 30 min; a special test tape was attached to a back side of the aluminum foil, a 12V electrode was installed for electrification for 30 sec, where a side of the steel plate served as the negative electrode and a side of the aluminum foil as the positive electrode; after electrification, an end of the steel plate is fixed on a lower fixture of a tensile tester and kept perpendicular to a horizontal plane, to achieve load zeroing; peeling strength at 2180° was measured at a test speed of 300 mm/min; and an average value of a stable 60 mm segment was calculated.

Retention test at room temperature and high temperature: 3 samples with a size of 25 mm×100 mm were prepared; one release film was peeled off, and an adhesive product was adhered to a special stainless steel plate with length marks, with a bonding length of 25 mm, to ensure that no bubbles generated and the adhesive product was centered on the steel plate; a 2 kg pressure roller was used to press back and forth once at a speed of 300 mm/min, and the adhesive product was cured at room temperature for 20 min; and after fixing with a stapler, the adhesive product was hung on a room temperature or high temperature (70° C.) retention testing device with a 1 kg weight applied, and time when the adhesive product fell off from the stainless steel plate was recorded.

Test results of adhesive products prepared from the electrically peelable compositions A1-B6 in the Examples and Comparative Examples are summarized in Table 2 below:

TABLE 2
Performance test statistics of adhesive products

| | | Peeling | Room | High |
|---|---|---|---|---|
| | Initial | strength after | temperature | temperature |
| | peeling | electrification | retention | retention |
| | strength | at 12 V for 30 s | time | time |
| | (N/mm) | (N/mm) | (h) | (h) |
| Example 1 | 0.8145 | 0.0178 | 760 | 760 |
| Example 2 | 0.9135 | 0.0234 | 590 | 590 |
| Example 3 | 0.9543 | 0.0138 | 600 | 600 |
| Example 4 | 0.9987 | 0.0129 | 780 | 780 |
| Example 5 | 0.9656 | 0.0136 | 650 | 650 |
| Example 6 | 0.8529 | 0.0085 | 280 | 280 |
| Example 7 | 0.7137 | 0.0041 | 100 | 100 |
| Example 8 | 0.7539 | 0.0314 | 500 | 500 |
| Example 9 | 0.8029 | 0.0098 | 300 | 300 |
| Comparative | 0.8879 | 0.0212 | 10 | 0.5 |
| Example 1 | | | | |
| Comparative | 0.9124 | 0.0217 | 6 | 0.2 |
| Example 2 | | | | |
| Comparative | 0.6529 | 0.0138 | 480 | 480 |
| Example 3 | | | | |
| Comparative | 0.7537 | 0.2526 | 24 | 10 |
| Example 4 | | | | |
| Comparative | 0.9120 | 0.0130 | 10 | 2 |
| Example 5 | | | | |
| Comparative | 0.9008 | 0.0147 | 20 | 3 |
| Example 6 | | | | |

The advantages of the examples of the present disclosure are analyzed by combining Table 1 and Table 2.

Seen from Table 1 and Table 2, results of comparing Comparative Example 1 with Example 2 show that, in the Comparative Example 1, the non-reactive tackifying resin GA-85 served as the auxiliary agent A, the non-reactive tackifying resin GA-85 could not synergistically participate in a crosslinking reaction of the acrylate-based polymer with the auxiliary agent B, and although the prepared adhesive product had good initial peeling strength and low peeling strength after electrification, room temperature retention time was only 10 h and high temperature retention time was only 0.5 h, both of which were shorter than those of Example 2; results of comparing Example 2 show that, in Example 2, the reactive tackifying resin ARDYME R-9520 served as the auxiliary agent A, the prepared adhesive product had good initial peeling strength and low peeling strength after electrification, and room temperature retention time was 590 h and high temperature retention time was 590 h; compared with Comparative Example 1, Example 2 had higher retention strength at room temperature and high temperature, indicating that when the auxiliary agent A accounted for 10%-30% of a total weight of the acrylate-based polymer and a mass ratio of the auxiliary agent A to the auxiliary agent B was (10-30):(1-10), the auxiliary agent A and the auxiliary agent B synergistically crosslinked with the acrylate-based polymer, and the adhesive layer formed by the electrically peelable composition maintained high peeling strength before electrification and easy peelability after electrification, as well as high adhesive retention.

Results of comparing Comparative Example 2 with Example 4 show that, in the Comparative Example 2, the non-reactive tackifying resin GA-85 served as the auxiliary agent A, the auxiliary agent B was not used, and although the prepared adhesive product had good initial peeling strength and low peeling strength after electrification, room temperature retention time was only 6 h and high temperature retention time was only 0.2 h, both of which were shorter than those of Example 4; results of comparing Example 4 show that, in Example 4, the reactive tackifying resin (resin of Formula II) served as the auxiliary agent A, polyurethane acrylate 6145-100 served as the auxiliary agent B, and the prepared adhesive product had good initial peeling strength and low peeling strength after electrification, and room temperature retention time was 780 h and high temperature retention time was 780 h; compared with Comparative Example 2, Example 4 had higher adhesive retention strength at room temperature and high temperature, indicating that when the auxiliary agent A accounted for 10%-30% of a total weight of the acrylate-based polymer and a mass ratio of the auxiliary agent A to the auxiliary agent B was (10-30):(1-10), the auxiliary agent A and the auxiliary agent B synergistically crosslinked with the acrylate-based polymer, and the adhesive layer formed by the electrically peelable composition maintained high peeling strength before electrification and easy peelability after electrification, as well as high adhesive retention.

Results of comparing Comparative Example 3 with Example 4 show that, in the Comparative Example 3, the reactive tackifying resin (resin of Formula II) served as the auxiliary agent A, but a dosage of the auxiliary agent A was too low, the auxiliary agent A accounted for only 5% of the total weight of the acrylate-based polymer, a mass ratio of the auxiliary agent A to the auxiliary agent B was 5:2, and the synergistic effect of the auxiliary agent A and the auxiliary agent B in participating in the crosslinking reaction of the acrylate-based polymer was poor; compared with that of the electrically peelable composition A4, the adhesive layer formed by the electrically peelable composition B3 prepared in Comparative Example 3 had lower initial peeling strength (only 0.6529 N/mm) was easily peeled from the adherend, where room temperature retention time was 480 h and high temperature retention time was only 480 h, both of which were shorter than those of Example 4; results of comparing Example 4 show that, in Example 4, the reactive tackifying resin (resin of Formula II) served as the auxiliary agent A, the auxiliary agent A accounted for 20% of the total weight of the acrylate-based polymer, and a mass ratio of the auxiliary agent A to the auxiliary agent B was 20:2, the prepared adhesive product had good initial peeling strength and low peeling strength after electrification, and room temperature retention time was 780 h and high temperature retention time was 780 h; compared with Comparative Example 3, Example 4 had higher adhesive retention strength at room temperature and high temperature, indicating that when the auxiliary agent A accounted for 10%-30% of a total weight of the acrylate-based polymer and a mass ratio of the auxiliary agent A to the auxiliary agent B was (10-30):(1-10), the auxiliary agent A and the auxiliary agent B synergistically crosslinked with the acrylate-based polymer, and the adhesive layer formed by the electrically peelable composition maintained high peeling strength before electrification and easy peelability after electrification, as well as high adhesive retention.

Results of comparing Comparative Example 4 with Example 4 show that, in the Comparative Example 4, the reactive tackifying resin (resin of Formula II) served as the auxiliary agent A, but a dosage of the auxiliary agent A was too high, the auxiliary agent A accounted for as high as 40% of the total weight of the acrylate-based polymer, and a mass ratio of the auxiliary agent A to the auxiliary agent B was 40:2, resulting in severe attenuation of cohesive strength of the electrically peelable composition B4; and compared with that of the electrically peelable composition A4, the adhesive layer formed by the electrically peelable composition B4 prepared in Comparative Example 4 had lower initial peeling strength (0.7537 N/mm) and higher peeling strength after electrification, and could not be well peeled off from the adherend, where room temperature retention time was only 24 h and high temperature retention time was only 10 h, both of which were shorter than those of Example 4.

Results of comparing Comparative Example 5 with Example 4 show that, in the Comparative Example 5, polyurethane acrylate 6145-100 served as the auxiliary agent B, the auxiliary agent A was not added, and although the prepared adhesive product had good initial peeling strength and low peeling strength after electrification, room temperature retention time was only 10 h and high temperature retention time was only 2 h, both of which were shorter than those of Example 4.

Results of comparing Comparative Example 6 with Example 4 show that, in the Comparative Example 6, the reactive tackifying resin (resin of Formula II) served as the auxiliary agent A but the auxiliary agent B was not added, and although the prepared adhesive product had good initial peeling strength and low peeling strength after electrification, room temperature retention time was only 20 h and high temperature retention time was only 3 h, both of which were shorter than those of Example 4; and results of comparing Example 4 show that, in Example 4, the UV-curable resin polyurethane acrylate 6145-100 served as the auxiliary agent B, which facilitated synergistic crosslinking of the auxiliary agent B and the acrylate-based polymer; and compared with Comparative Example 6, Example 4 had higher adhesive retention strength at room temperature and high temperature.

By adjusting types and proportions of monomers for preparing the acrylate-based polymer, as well as types and proportions of other components, the adhesive layers formed by the electrically peelable compositions prepared in Examples 5 to 9 also maintained high peeling strength before electrification and easy peelability after electrification, as well as high adhesive retention.

To sum up, due to the synergistic compatibility of raw material components such as the acrylate-based polymer, the ionic liquid, the auxiliary agent A, and the auxiliary agent B, cohesive strength of the electrically peelable composition provided by an example of the present disclosure is significantly improved, and the adhesive layer formed by the electrically peelable composition has high peeling strength and adhesive retention before electrification, and is easily peeled from the adherend after electrification, such that an adhesive product prepared from the electrically peelable composition has both electrical peelability and excellent adhesive properties.

The various technical features described above may be combined arbitrarily. Although not all possible combinations of these technical features have been described, any combination of these technical features should be considered as being encompassed by this specification as long as such combinations do not conflict with one another.

Finally, it should be noted that the above examples are only used to illustrate the technical solutions of the present disclosure, but not to limit them; although the present disclosure has been described in detail with reference to the foregoing embodiments, those skilled in the art should understand that: the technical solutions described in the foregoing embodiments can still be modified, or some or all of the technical features thereof can be equivalently replaced; and these modifications or replacements do not make the essence of the corresponding technical solutions deviate from the scope of the technical solutions of the embodiments of the present disclosure.

1. An electrically peelable composition, comprising the following components:
an acrylate-based polymer, an ionic liquid, an auxiliary agent A, and an auxiliary agent B;
the auxiliary agent A accounts for 10%-30% of a total weight of the acrylate-based polymer;
a mass ratio of the auxiliary agent A to the auxiliary agent B is (10-30):(1-10); and
the auxiliary agent A and the auxiliary agent B are configured to undergo a synergistic crosslinking reaction with the acrylate-based polymer.

2. The electrically peelable composition according to claim 1, satisfying one or more of the following conditions A to H:
A) in parts by weight, relative to 100 parts of the acrylate-based polymer, the electrically peelable composition comprises 2-30 parts of the ionic liquid, 10-30 parts of the auxiliary agent A, and 1-10 parts of the auxiliary agent B;
B) the auxiliary agent A comprises a linear resin containing active functional groups with a molecular weight of 200-1,000;
C) the auxiliary agent B comprises a UV-curable resin and/or a non-UV-curable resin;
D) an anion of the ionic liquid is a bis(fluorosulfonyl)imide anion;
E) a cation of the ionic liquid comprises one or more of a nitrogen-containing onium cation, a sulfur-containing onium cation, a phosphorus-containing onium cation, an imidazolium-based cation, an ammonium-based cation, or a pyridinium-based cation;
F) solid content of the acrylate-based polymer is 10-50%;
G) a weight-average molecular weight of the acrylate-based polymer is 100,000 to 5,000,000, preferably 200,000 to 4,000,000, and more preferably 300,000 to 3,000,000; and
H) a glass transition temperature of the acrylate-based polymer is below 0° C., preferably below −20° C., and more preferably below −40° C.

3. The electrically peelable composition according to claim 1, wherein the auxiliary agent A comprises one or more of a rosin-based carboxyl-containing tackifying resin, an epoxy-based epoxy-containing tackifying resin, a phenol-based hydroxyl-containing tackifying resin, an acrylate-based tackifying resin, and resins represented by the following formulas I, II, and III, 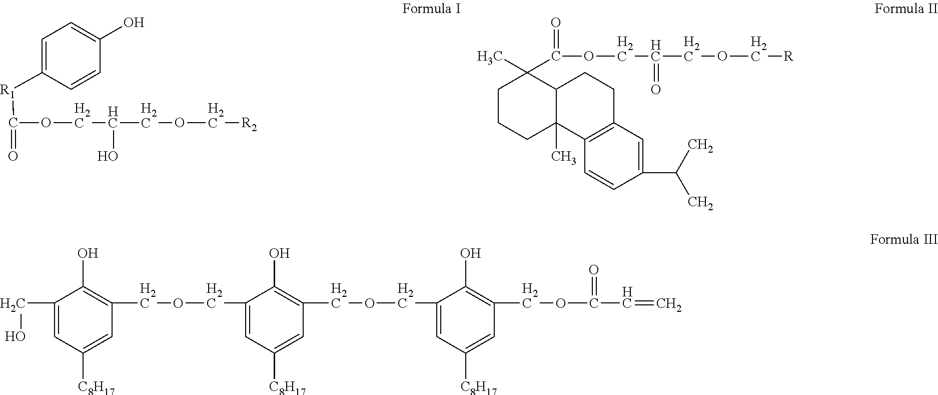
in the formulas, R₁ represents a phenyl group, a cyclohexyl group, or a methylene group; R₂ represents a methyl group, a hydroxyl group, a vinyl group, a carboxyl group, an epoxy group, a mercapto group, or an acryloyloxy group; and R represents a methyl group, a hydroxyl group, a vinyl group, a carboxyl group, an epoxy group, a mercapto group, or an acryloyloxy group.

4. The electrically peelable composition according to claim 2, wherein as a non-UV-curable resin, the auxiliary agent B comprises one or more of an isocyanate-based crosslinking agent, an epoxy-based crosslinking agent, an aziridine-based crosslinking agent, or a metal chelate-based crosslinking agent; or
as a UV-curable resin, the auxiliary agent B comprises one or more of epoxy acrylate, polyurethane acrylate, or polyester acrylate.

5. The electrically peelable composition according to claim 1, wherein the acrylate-based polymer is made from main raw materials comprising a principal unit, a functional unit, and an initiator;
wherein the principal unit is alkyl (meth)acrylate containing an alkyl group with 1-14 carbon atoms;
the functional unit comprises a carboxyl-containing acrylate-based monomer and/or a hydroxyl-containing acrylate-based monomer; and
the initiator comprises either a thermal polymerization initiator or a photoinitiator.

6. The electrically peelable composition according to claim 5, satisfying one or more of the following conditions I to M:
I) when the initiator is a thermal polymerization initiator, a mass ratio of the principal unit to the functional unit is (70-95):(5-30);
J) when the initiator is a photoinitiator, raw materials of the acrylate-based polymer further comprise a multifunctional UV monomer; a mass ratio of the principal unit to the functional unit and to the multifunctional UV monomer is (60-95):(3-30):(2-10);
K) the raw materials of the acrylate-based polymer further comprise a polymerization solvent, and the polymerization solvent comprises one or more of an aliphatic hydrocarbon, an ester compound, and an aromatic hydrocarbon;
L) the thermal polymerization initiator comprises any one of azo polymerization initiators such as 2,2′-azobisisobutyronitrile, 2,2′-azobis(2-methylpropionamidine)disulfide, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), dimethyl 2,2′-azobis(2-methylpropanoate), 2,2′-azobis [2-methyl-N-(phenylmethyl) propionamidine]dihydrochloride, 2,2′-azobis [2-(3,4,5,6-tetrahydropyrimidin-2-yl) propane]dihydrochloride, or 2,2′-azobis [2-(2-imidazolin-2-yl) propane], or any one of persulfate compounds such as potassium persulfate or ammonium persulfate; and
M) the photoinitiator comprises any one of Type I photoinitiators such as hydroxypropiophenone, alkylaminoacetophenone, benzoin ether, or phosphine oxide, or any one of Type II initiators such as benzophenone, substituted benzophenone, anthraquinone, benzoylformate, camphorquinone, or thioxanthone.

7. A method for preparing the electrically peelable composition according to claim 1, comprising:
step of preparing an acrylate-based polymer: mixing a principal unit, a functional unit, and a polymerization solvent with a thermal polymerization initiator in a predetermined ratio for reaction to obtain an acrylate-based polymer A; or mixing a principal unit, a functional unit, a multifunctional UV monomer, and a polymerization solvent with a photoinitiator in a predetermined ratio for reaction to obtain an acrylate-based polymer B; and
step of preparing an electrically peelable composition: mixing the acrylate-based polymer A or the acrylate-based polymer B with remaining components in a predetermined ratio for reaction to obtain an electrically peelable composition.

8. The method for preparing the electrically peelable composition according to claim 7, wherein the step of preparing an acrylate-based polymer specifically comprises:
mixing a monomer mixture A composed of a principal unit and a functional unit with a polymerization solvent at a mass ratio of 1:(1-9), and adding a thermal polymerization initiator accounting for 0.2-1% by mass of the monomer mixture A for a heating reaction to obtain an acrylate-based polymer A; or
mixing a monomer mixture B composed of a principal unit, a functional unit, and a multifunctional UV monomer with a polymerization solvent at a mass ratio of 1:(1-9), and adding a photoinitiator accounting for 1-5% by mass of the monomer mixture B for a reaction under UV irradiation to obtain an acrylate-based polymer B.

9. The method for preparing the electrically peelable composition according to claim 7, wherein in the step of preparing an electrically peelable composition, when the acrylate-based polymer B is mixed with remaining components in a predetermined ratio for reaction, the remaining components further comprise a photoinitiator accounting for 1-5% of a total mass of the acrylate-based polymer B.

10. An adhesive product, comprising an adhesive layer formed by the electrically peelable composition according to claim 1 or the electrically peelable composition prepared by the preparation method.
